(19) United States
(12) Patent Application Publication
(10) Pub. No.: US 2016/0091778 A1
(43) Pub. Date: Mar. 31, 2016

(54) CAMERA FILTER FRAME AND CAMERA FILTER UNIT

(71) Applicant: KABUSHIKI KAISHA TSUSO, Nagano (JP)

(72) Inventor: Hideo KOBAYASHI, Nagano (JP)

(21) Appl. No.: 14/845,923

(22) Filed: Sep. 4, 2015

(30) Foreign Application Priority Data
Sep. 29, 2014 (JP) 2014-199278

(51) Int. Cl. G03B 17/12

(52) U.S. Cl. CPC G03B 17/12

(57) ABSTRACT

A filter holding ring of a camera filter unit includes an annular plate into which an optical filter is inserted on the inner peripheral side, and front and rear abutments that grip the optical filter. The rear abutment is formed through swaging processing to bend a rear end of the annular plate toward the inner peripheral side. The annular plate includes a triangular annular groove tapering toward the outer peripheral side, on the inner peripheral surface. In the swaging processing, the annular plate is bent toward the inner peripheral side from the portion where the annular groove is formed. Bending the thin portion of the annular plate enables the rear abutment to be formed with relatively weak force. Even when the rear abutment is formed with weak force, the rear abutment can be formed accurately, so that the optical filter can be gripped securely by the front and rear abutments.

### BACKGROUND OF THE INVENTION

1. Field of the Invention

The present invention relates to a camera filter frame and a camera filter unit that grip an optical filter through swaging.

2. Description of the Related Art

A camera filter unit to be attached to a lens-barrel of an imaging lens has a filter frame made of metal such as aluminum. The filter frame includes, on the outer peripheral surface of the rear end, an external thread for mounting the filter frame into the lens-barrel, and, on the inner peripheral surface of the front end, an internal thread for mounting a lens cap, a hood, and the like. The filter frame also includes an annular filter holder that holds the optical filter on the inner peripheral side. The filter holder includes an annular plate into which the optical filter is inserted, and a front abutment and a rear abutment that grip the optical filter by abutting on the optical filter from both sides in the axial direction.

The rear abutment is formed through swaging. Specifically, a tapered surface (swaging tongue) inclining to the inner peripheral side toward the rear is disposed at the rear end of the annular plate, and a tapered surface that faces forward and is abuttable on the tapered surface of the annular plate is disposed at a swaging die. In swaging processing, the optical filter is first inserted into the annular plate to abut on the front abutment. The tapered surface of the annular plate is then caused to abut on the tapered surface of the swaging die. Subsequently, the rear end of the annular plate is pressurized by the swaging die and pressed against the optical filter. As a result, the rear end of the annular plate is bent toward the inner peripheral side to be the rear abutment. The camera filter unit in which the rear abutment is formed through swaging is disclosed in Japanese Patent No. 5431611.

In such swaging processing, the deformation position (bend position) in the annular plate sometimes varies and shifts from the target deformation position to the front or the rear. If the deformation position shifts from the target deformation position to the rear, the rear abutment that is formed through swaging does not closely touch the optical filter, so that the optical filter is not securely gripped by the front abutment and the rear abutment.

To ensure that the optical filter is gripped securely by the front abutment and the rear abutment, the annular plate may be deformed with strong force so that the rear abutment closely touches the optical filter even when the deformation position shifts to the rear. Applying stronger force to deform the annular plate in view of the deformation position shifted to the rear may, however, damage the surface of the filter frame. For example, applying stronger force to deform the annular plate may damage an anodized aluminum coating formed on the surface of the filter frame (annular plate).

An object of the present invention is to provide a camera filter unit on which swaging processing to grip an optical filter can be performed accurately with weaker force than that in conventional swaging processing in view of the above.

### SUMMARY OF THE INVENTION

To solve the above object, a first aspect of the invention provides a camera filter frame including an annular plate into which an optical filter is inserted on the inner peripheral side, and a first abutment and a second abutment that grip the optical filter by abutting on the optical filter from one side and the other side in the axial direction. The second abutment is formed by causing the end on the other side of the annular plate in the axial direction to be bent toward the inner peripheral side. In such a camera filter frame, the annular plate includes an annular groove on at least one of the outer peripheral surface and the inner peripheral surface, and the second abutment is formed by bending a portion of the annular plate where the annular groove is formed toward the inner peripheral side.

In the first aspect of the present invention, forming the annular groove provides a thin portion in the annular plate, and thus the annular plate is deformed from the portion where the annular groove is formed by performing swaging processing in which the rear end of the annular plate is bent toward the inner peripheral side. Specifically, the annular groove defines the deformation position of the annular plate in the swaging processing. Consequently, the force to deform the annular plate does not need to be made stronger than necessary in view of a shift of the deformation position. The thin portion of the annular plate is bent through swaging, and thus the second abutment can be formed with weaker force than that in the case where no annular groove is disposed. Additionally, the deformation position of the annular plate can be defined, and thus the second abutment can be formed accurately. Hence, the optical filter can be gripped securely by the first abutment and the second abutment.

In a second aspect of the present invention, to hold an optical filter including a chamfered surface on the outer peripheral side of a filter surface, the second abutment can abut on a tapered chamfered surface disposed between a filter surface and an annular outer peripheral surface of the optical filter. The annular groove can be disposed at a position overlapping a corner between the annular outer peripheral surface and the chamfered surface when the optical filter abutting on the first abutment in the state before the annular plate is bent is seen from a direction orthogonal to the axial direction. This structure enables the rear end of the annular plate to be bent easily along the chamfered surface of the optical filter to abut on the chamfered surface. The case where the position of the inner wall surface defining the end on one side of the annular groove in the axial direction is aligned with the position of the corner is also included in the state where the annular groove is disposed at a position overlapping the corner when seen from the direction orthogonal to the axial direction.

In a third aspect of the present invention, to bend the second abutment along the chamfered surface of the optical filter, the annular groove can be disposed on the inner peripheral surface. The annular groove can have a triangular sectional shape tapering toward the outer peripheral side in the state before the annular plate is bent. This structure enables deformation through swaging to be started from the bottom (the apex on the outer peripheral side of the triangular sectional shape) of the annular groove in the annular plate.

In a fourth aspect of the present invention, the annular groove can include an annular inner wall surface that is flat and extends orthogonally to the axial direction and a tapered inner wall surface that inclines from the end of the outer peripheral side of the annular inner wall surface to the inner peripheral side toward the other side in the axial direction. This structure enables the depth dimension of the annular groove and the angle of the tapered inner wall surface to the annular inner wall surface to be defined accurately.

In a fifth aspect of the present invention, the annular groove is preferably closed with the second abutment formed. This structure enables the angle at which the rear end of the annular plate is bent to the inner peripheral side to be defined by the angle of the tapered inner wall surface to the annular inner wall surface.

In a sixth aspect of the present invention, the annular plate preferably includes, on one side of the annular groove in the axial direction, an adhesive injection hole that penetrates in a direction intersecting the axial direction. This structure enables an adhesive to be interposed between the annular plate and the optical filter by injecting the adhesive into inner peripheral side of the annular plate through the adhesive injection hole after the optical filter is inserted into the annular plate. The adhesive also enables the optical filter to be fixed to the annular plate, and thus the optical filter can be gripped securely even when the second abutment is formed with weak force.

In a seventh aspect of the present invention, a filter holding ring that includes the annular plate, the first abutment, and the second abutment, and a filter frame that holds the filter holding ring on the inner peripheral side can be included. The filter frame can include a stopper that is abuttable on the second abutment when the second abutment comes apart from the optical filter. Even when the second abutment formed by being bent toward the inner peripheral side is deformed in the direction returning to the original state, this structure avoids further deformation of the second abutment by causing the second abutment to abut on the stopper. The optical filter can thus be prevented from dropping.

A camera filter unit according to an eighth aspect of the present invention includes the camera filter frame and an optical filter held by the camera filter frame.

According to the present invention, an optical filter does not drop from a camera filter frame even when swaging processing to grip the optical filter is performed with weaker force than that in conventional swaging processing.

### BRIEF DESCRIPTION OF THE DRAWINGS

FIG. 1 is a perspective view of a camera filter unit according to a first embodiment of the present invention;

FIG. 2A is a longitudinal sectional view of the camera filter unit according to the first embodiment;

FIG. 2B is a partially enlarged sectional view of the camera filter unit according to the first embodiment;

FIG. 3A is a diagram for explaining a manufacturing method of the camera filter unit according to the first embodiment;

FIG. 3B is a diagram for explaining the manufacturing method of the camera filter unit according to the first embodiment;

FIG. 4A is a diagram illustrating an annular groove according to a modification disposed on an annular plate;

FIG. 4B is a diagram illustrating an annular groove according to another modification disposed on the annular plate;

FIG. 4C is a diagram illustrating the annular groove according to another modification disposed on the annular plate;

FIG. 5 is a diagram illustrating a camera filter unit according to a second embodiment;

FIG. 6A is a longitudinal sectional view of the camera filter unit according to a third embodiment;

FIG. 6B is a partially enlarged sectional view of the camera filter unit according to the third embodiment;

FIG. 7A is a diagram for explaining a manufacturing method of the camera filter unit according to the third embodiment;

FIG. 7B is a diagram for explaining the manufacturing method of the camera filter unit according to the third embodiment;

FIG. 8A is a diagram illustrating a camera filter unit according to a modification of the third embodiment; and

FIG. 8B is a diagram illustrating the camera filter unit according to the modification of the third embodiment.

### DETAILED DESCRIPTION OF THE PREFERRED EMBODIMENTS

The following describes a camera filter unit to which the present invention is applied with reference to the drawings.

### First Embodiment

### Entire Structure

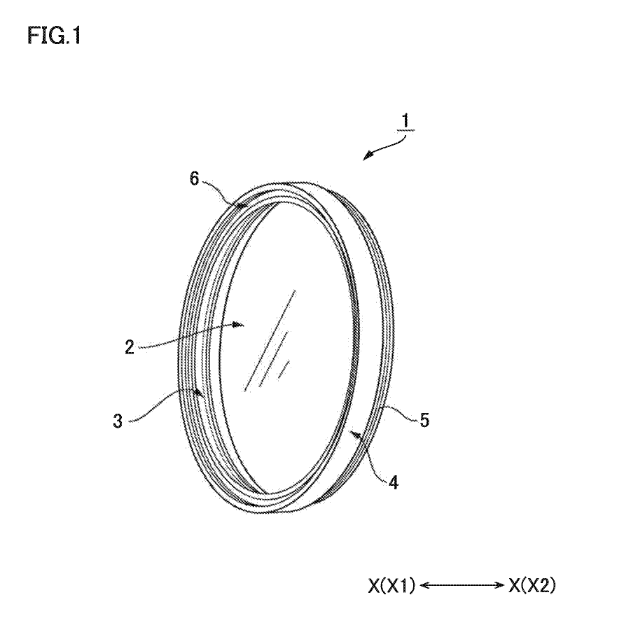

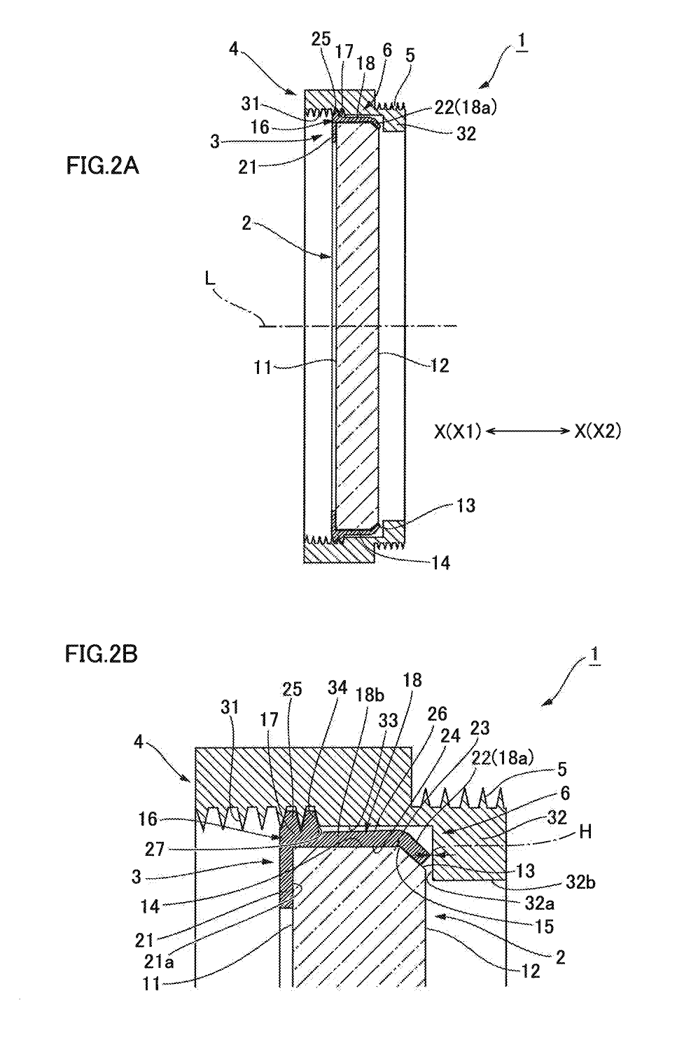

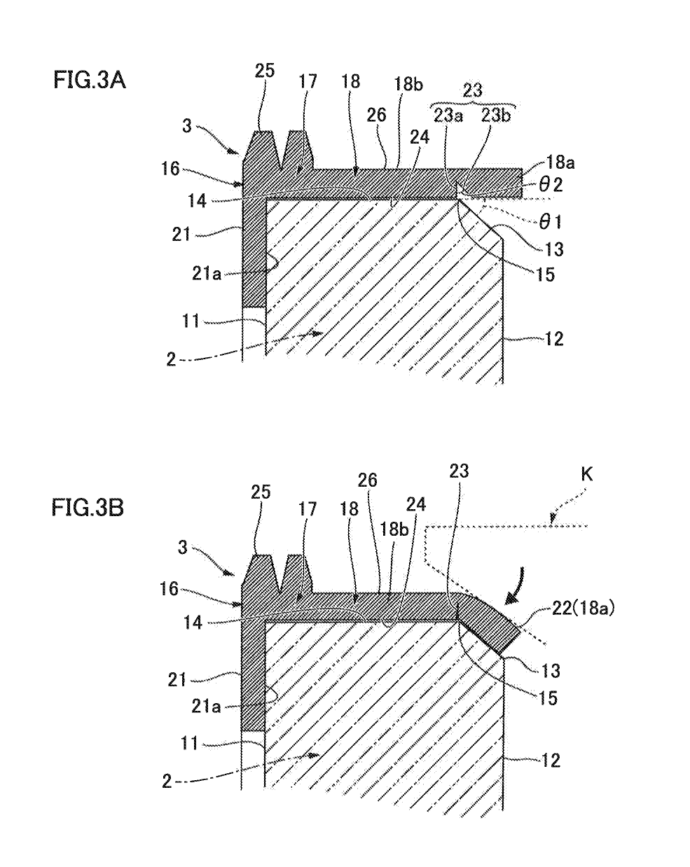

FIG. 1 is a perspective view of a camera filter unit to which the present invention is applied. FIG. 2A is a longitudinal sectional view schematically illustrating a camera filter unit 1 in FIG. 1. FIG. 2B is a partially enlarged sectional view in which the vicinity of the outer peripheral edge of an optical filter 2 is enlarged. FIGS. 3A and 3B are diagrams for explaining a manufacturing method of the camera filter unit 1. As illustrated in FIG. 1, the camera filter unit 1 according to the present invention has the optical filter 2, a filter holding ring 3 in which the optical filter 2 is fitted coaxially, and a filter frame 4 that holds the filter holding ring 3 coaxially from the outer peripheral side. The filter holding ring 3 and the filter frame 4 constitute a camera filter frame 6 that holds the optical filter 2. The filter holding ring 3 and the filter frame 4 are formed of a metal base such as aluminum and brass. In the present embodiment, the filter holding ring 3 and the filter frame 4 are made of aluminum and their surfaces are anodized. In the following description, the direction of an axis L of the filter holding ring 3 and the filter frame 4 is a fore-and-aft direction X of the camera filter unit 1.

The optical filter 2 and the filter holding ring 3 are disposed without being exposed from the front and rear ends of the filter frame 4. A frame side external thread 5 is formed on the outer peripheral surface of the rear end of the filter frame 4. The frame side external thread 5 is a mounting portion for mounting the camera filter unit 1 into a lens-barrel of an imaging lens or a camera.

Optical Filter

As illustrated in FIG. 2A, the optical filter 2 has a disc-like shape and includes a front filter surface 11 and a rear filter surface 12 orthogonal to the axis L. As illustrated in FIG. 2B, to the outer peripheral edge of the rear filter surface 12, a tapered annular chamfered surface 13 is continuous, inclining to the outer peripheral side toward a front X1. To the front end edge of the annular chamfered surface 13, an annular outer peripheral surface 14 is continuous, with a constant diameter dimension. To the front end edge of the annular outer peripheral surface 14, the front filter surface 11 is continuous. As illustrated in FIG. 3A, the inclination angle θ1 of the annular chamfered surface 13 to the annular outer peripheral surface 14 is 45°. Note that the optical filter 2 includes the tapered annular chamfered surface 13 inclining to the inner peripheral side toward the front X1 between the annular outer peripheral surface 14 and the front filter surface 11 in some cases.

Filter Holding Ring

As illustrated in FIG. 2A, the filter holding ring 3 includes a ring body 16 located on the outer peripheral side of the optical filter 2. As illustrated in FIG. 2B, the ring body 16 includes an external thread portion 17 in which a ring side external thread 25 is formed on the outer peripheral surface, and an annular plate 18 that extends from the end of the inner peripheral side of the external thread portion 17 to the rear.

On the front end edge of the external thread portion 17, a front abutment (first abutment) 21 is formed. The front abutment 21 is an annular protrusion protruding from the external thread portion 17 to the inner peripheral side. The annular front end surface of the front abutment 21 is an irregular reflection surface on which a plurality of grooves concentric with the ring body 16 are formed. An annular rear end surface 21a of the front abutment 21 is a flat surface orthogonal to the axis L. The front abutment 21 abuts, from the front X1, on the outer peripheral edge of the front filter surface 11 of the optical filter 2 inserted into the inner peripheral side of the ring body 16. The front abutment 21 prevents the optical filter 2 from moving toward the front X1.

A rear end 18a of the annular plate 18 is a rear abutment (second abutment) 22 that extends along the annular chamfered surface 13 of the optical filter 2. The rear abutment 22 abuts, from a rear X2, on the annular chamfered surface 13 of the optical filter 2 inserted into the inner peripheral side of the ring body 16 to prevent the optical filter 2 from moving to the rear X2. The rear abutment 22 and the front abutment 21 grip the optical filter 2 from both sides in the direction of the axis L.

The portion of the annular plate 18 toward the front X1 from the rear abutment 22 is a cylinder 18b. The annular inner peripheral surface of the cylinder 18b is seamlessly continuous to the annular inner peripheral surface of the external thread portion 17, and these annular inner peripheral surfaces constitute a filter holding surface 24 that holds the optical filter 2 from the outer peripheral side. The cylinder 18b also includes a ring side annular outer peripheral surface 26 that is smooth and has a constant diameter dimension. The ring side annular outer peripheral surface 26 is located closer to the inner peripheral side than the ring side external thread 25 is, and a ring side annular rearward surface 27 is disposed between the ring side annular outer peripheral surface 26 and the ring side external thread 25 to connect them.

The annular plate 18 includes an annular groove 23 on its inner peripheral surface. The rear abutment 22 is formed by bending the portion of the annular plate 18 in which the annular groove 23 is disposed, along a corner 15 toward the inner peripheral side. The annular groove 23 is closed with the rear abutment 22 formed.

Filter Frame

As illustrated in FIGS. 2A and 2B, a frame side internal thread 31 is formed in the area with a constant width on the inner peripheral surface of the filter frame 4, from the front end edge toward the rear X2. The ring side external thread 25 is threadedly engaged with the frame side internal thread 31, and the filter holding ring 3 is screwed in the filter frame 4 from the front X1. The width dimension of the area in which the frame side internal thread 31 is formed is larger than the width dimension of the area in which the ring side external thread 25 is formed. Thus, with the filter holding ring 3 held by the filter frame 4, the front end of the frame side internal thread 31 is exposed. The exposed front end of the frame side internal thread 31 is used as an attaching portion of a lens cap and a hood or a coupling portion for coupling other camera filter units.

The filter frame 4 includes an annular protrusion (stopper) 32 protruding to the inner peripheral side on the rear end 18a. The annular protrusion 32 includes an annular front end surface 32a that is flat and faces the front X1 and an annular inner peripheral surface 32b that extends from the end edge on the inner peripheral side of the annular front end surface 32a to the rear X2 parallel to the axis L. On the inner peripheral surface of the filter frame 4, a frame side annular inner peripheral surface 33 having a constant diameter dimension is formed between the area in which the frame side internal thread 31 is formed and the annular front end surface 32a. The frame side annular inner peripheral surface 33 is located slightly closer to the inner peripheral surface than the frame side internal thread 31 is, and a frame side annular forward surface 34 is disposed between the frame side annular inner peripheral surface 33 and the frame side internal thread 31 to connect them.

With the filter holding ring 3 held to the inner peripheral side of the filter frame 4, the frame side annular forward surface 34 of the filter frame 4 abuts on the ring side annular rearward surface 27 of the filter holding ring 3. The frame side annular inner peripheral surface 33 faces the ring side annular outer peripheral surface 26 with a narrow spacing therebetween.

Additionally, the annular front end surface 32a of the annular protrusion 32 faces the rear end of the filter holding ring 3 (the rear end of the second abutment) with a nominal spacing H therebetween. In the present embodiment, the spacing H is 0.1 mm to 0.3 mm. The annular inner peripheral surface 32b of the annular protrusion 32 is located closer to the inner peripheral surface than the rear end of the filter holding ring 3 is, and the rear abutment 22 is hidden by the annular protrusion 32 when the camera filter unit 1 is seen from the rear X2 in the direction of the axis L. An adhesive is interposed between the filter holding ring 3 and the filter frame 4, and the filter holding ring 3 is fixed to the filter frame 4 in a relatively unrotatable manner.

Manufacturing Method of Camera Filter Unit

As illustrated in FIG. 3A, to manufacture the camera filter unit 1, the optical filter 2 is first fitted from the rear X2 into the filter holding ring 3 without the rear abutment 22 disposed. Swaging processing is then performed in which the rear end 18a of the filter holding ring 3 (the rear end 18a of the annular plate 18) is bent toward the inner peripheral side.

As illustrated in FIG. 3A, in the state before the filter holding ring 3 (annular plate 18) is bent, the rear end 18a of the annular plate 18 extends parallel to the annular outer peripheral surface 14 of the optical filter 2 (parallel to the axis L). The annular groove 23, which is disposed on the inner peripheral surface of the annular plate 18, indicates a triangular sectional shape tapering toward the outer peripheral side when the filter holding ring 3 is cut by a plane including the axis L. The annular groove 23 is disposed in a portion located outside in the radial direction of the corner 15 on the border between the annular chamfered surface 13 and the annular outer peripheral surface 14 of the optical filter 2.

More specifically, the annular groove 23 is defined by an annular inner wall surface 23a orthogonal to the axis L and a tapered inner wall surface 23b inclining from the end edge of the outer peripheral side of the annular inner wall surface 23a to the inner peripheral side toward the rear X2. The height dimension of the annular inner wall surface 23a (the depth dimension of the annular groove 23) is one third of the thickness dimension of the annular plate 18. In the present embodiment, whereas the thickness dimension of the annular plate 18 is 0.3 mm, the depth dimension of the annular groove 23 is 0.1 mm. Note that the depth dimension of the annular groove 23 is preferably smaller than or equal to half of that of the annular plate 18 in view of the strength of the annular plate 18.

With the optical filter 2 abutting on the front abutment 21, the annular inner wall surface 23a is located slightly closer to the front X1 than the corner 15 of the optical filter 2 is. Thus, when seen from the direction orthogonal to the direction of the axis L, the annular groove 23 and the corner 15 overlap one another. The corner 15 is located closer to the end edge of the inner peripheral side of the annular inner wall surface 23a than the end edge of the inner peripheral side of the tapered inner wall surface 23b. Additionally, the inclination angle θ2 of the tapered inner wall surface 23b to the annular inner wall surface 23a is 45°, which corresponds to the inclination angle θ1 of the annular chamfered surface 13 to the annular outer peripheral surface 14 of the optical filter 2. In other words, the inclination angle θ2 of the tapered inner wall surface 23b to the annular inner wall surface 23a corresponds to the angle at which the annular plate 18 is bent to the inner peripheral side.

As illustrated in FIG. 3B, in the swaging processing, a force is applied to the rear end 18a of the annular plate 18 of the filter holding ring 3 using a swaging die K. As a result, the annular plate 18 starts being deformed from the portion where the annular groove 23 is formed. Subsequently, the rear end 18a of the annular plate 18 is bent to the inner peripheral side with the swaging die K until the annular groove 23 is closed (until the annular inner wall surface 23a comes in contact with the tapered inner wall surface 23b). In this manner, the optical filter 2 is gripped from both sides in the direction of the axis L by the front abutment 21 and the rear abutment 22, thereby being fixed to the filter holding ring 3.

An adhesive (not illustrated) is then applied to the internal corner between the ring side annular outer peripheral surface 26 of the filter holding ring 3 and the ring side annular rearward surface 27. Subsequently, as illustrated in FIGS. 2A and 2B, the filter holding ring 3 is inserted into the filter frame 4, the ring side external thread 25 is threadedly engaged with the frame side internal thread 31, and the filter holding ring 3 is screwed in. The filter holding ring 3 is screwed in the filter frame 4 until the ring side annular rearward surface 27 of the filter holding ring 3 abuts on the frame side annular forward surface 34 of the filter frame 4, and fixed to the filter frame 4. Thereafter, the filter holding ring 3 and the filter frame 4 are left to stand until they are fixed to each other in a relatively unrotatable manner by curing of the adhesive. This completes the camera filter unit 1.

When the thickness dimension from the front filter surface 11 to the corner 15 in the optical filter 2 (the length dimension of the annular outer peripheral surface 14 in the direction of the axis L) varies, a plurality of types of the filter holding rings 3 are prepared in which the position where the annular groove 23 is formed is changed in the direction of the axis L. After the thickness dimension from the front filter surface 11 to the corner 15 in the optical filter 2 is measured, one of the filter holding rings 3 is selected in which the annular groove 23 is disposed at a position overlapping the corner 15 to manufacture the camera filter unit 1. The filter holding ring 3 to be selected is such that the length dimension from the annular rear end surface 21a of the front abutment 21 to the annular inner wall surface 23a of the annular groove 23 in the direction of the axis L is smaller than or equal to the thickness dimension from the front filter surface 11 to the corner 15 in the optical filter 2, and the length dimension from the annular rear end surface 21a of the front abutment 21 to the end edge of the inner peripheral side of the tapered inner wall surface 23b in the direction of the axis L is larger than the thickness dimension from the front filter surface 11 to the corner 15 in the optical filter 2.

Working Effect

According to the present embodiment, forming the annular groove 23 provides a thin portion in the annular plate 18, and thus the annular plate 18 is deformed from the portion where the annular groove 23 is formed by performing the swaging processing in which the rear end 18a of the annular plate 18 is bent toward the inner peripheral side. Specifically, the annular groove 23 defines the deformation position of the annular plate 18 in the swaging processing. Consequently, the force to deform the annular plate 18 does not need to be made stronger than necessary in view of a shift of the deformation position. The thin portion of the annular plate 18 is bent through swaging, and thus the rear abutment 22 can be formed with weaker force than that in the case where the annular groove 23 is not disposed. Additionally, the deformation position of the annular plate 18 in the swaging processing is defined, and thus the rear abutment 22 can be formed accurately. Hence, the optical filter 2 can be gripped securely by the front abutment 21 and the rear abutment 22.

In the present embodiment, the sectional shape of the annular groove 23 is a triangle, and thus deformation through swaging can be started from the bottom (the apex on the outer peripheral side of the triangular sectional shape) of the annular groove 23 in the annular plate 18. Additionally, the annular groove 23 includes the annular inner wall surface 23a that extends orthogonally to the direction of the axis L and the tapered inner wall surface 23b. The depth of the annular groove 23 and the angle of the tapered inner wall surface 23b to the annular inner wall surface 23a can thus be controlled easily.

In the present embodiment, the inclination angle θ2 of the tapered inner wall surface 23b to the annular inner wall surface 23a corresponds to the inclination angle θ1 of the annular chamfered surface 13 to the annular outer peripheral surface 14 of the optical filter 2, and with the rear abutment 22 formed, the annular groove 23 is closed by causing the annular inner wall surface 23a to abut on the tapered inner wall surface 23b. Consequently, the angle at which the rear end 18a of the annular plate 18 is bent to the inner peripheral side can be defined accurately by the inclination angle θ2 of the tapered inner wall surface 23b to the annular inner wall surface 23a.

In the present embodiment, no tapered surface (swaging tongue) inclining to the inner peripheral side toward the rear X2 is required to be disposed at the rear end 18a of the annular plate 18 for swaging processing. The portion of the annular plate 18 toward the rear X2 from the annular groove 23 can thus have a constant thickness.

Furthermore, in the present embodiment, when the optical filter 2 the thickness dimension of which varies is used to manufacture the camera filter unit 1, the filter holding ring 3 is used in which the annular groove 23 is disposed at the position corresponding to the thickness dimension from the front filter surface 11 to the corner 15 in the optical filter 2. As a result, the rear abutment 22 can be formed accurately regardless of the varied thickness dimension of the optical filter 2. Consequently, the optical filter 2 can be gripped securely by the front abutment 21 and the rear abutment 22 regardless of the varied thickness dimension of the optical filter 2.

The position of the annular inner wall surface 23a of the annular groove 23 in the direction of the axis L may be aligned with the position of the corner 15 of the optical filter 2. Specifically, the position of the end edge on the inner peripheral side of the inner wall surface defining the end of the annular groove 23 at the front X1 may be aligned with the position of the corner 15. Note that the case where the position of the end edge on the inner peripheral side of inner wall surface defining the end of the annular groove 23 at the front X1 is aligned with the position of the corner 15 is also included in the state where the annular groove 23 is disposed at a position overlapping the corner 15 when seen from the direction orthogonal to the direction of the axis L in the present specification.

Modifications

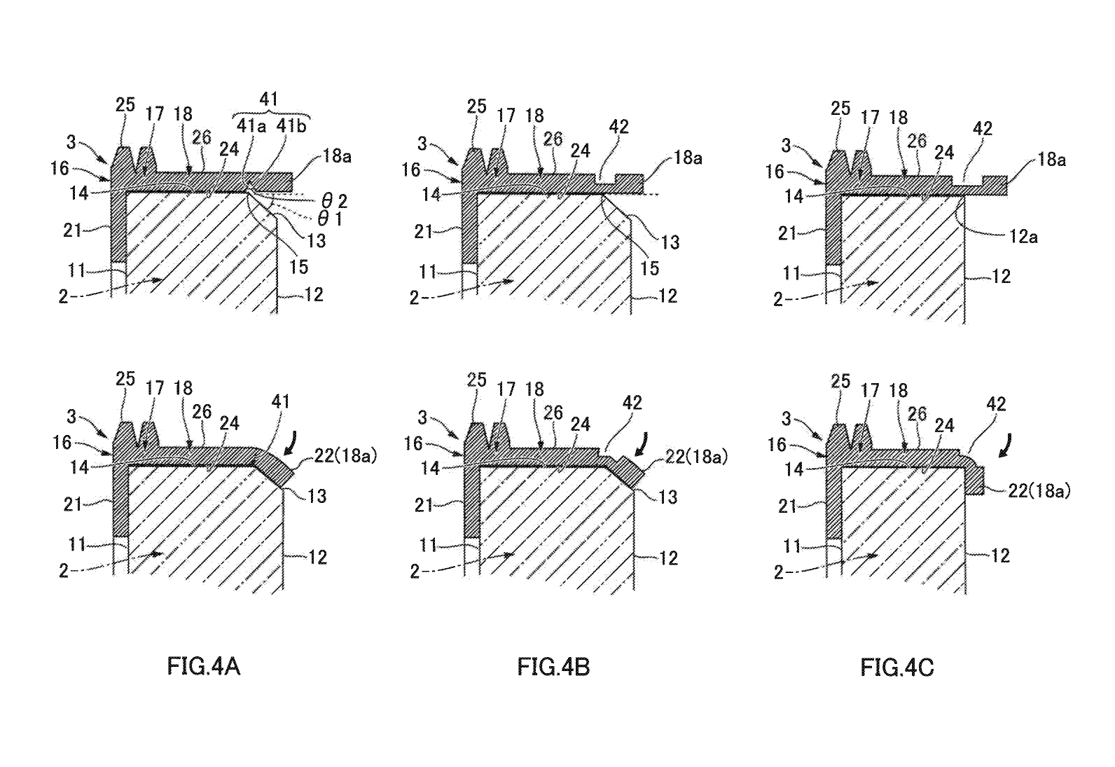

FIGS. 4A to 4C are diagrams illustrating an annular groove disposed on the annular plate 18 according to modifications. Upper diagrams in FIGS. 4A to 4C are partial sectional views of the filter holding ring 3 and the optical filter 2 before the rear abutment 22 is formed, while lower diagrams in FIGS. 4A to 4C are partial sectional views of the filter holding ring 3 and the optical filter 2 after the rear abutment 22 is formed. As illustrated in FIG. 4A, an annular groove 41 according to a first modification has a triangular sectional shape, and includes a tapered inner wall surface 41a facing the rear X2 and a tapered inner wall surface 41b facing the front X1. The annular groove 41 is formed at a position where the corner 15 is included in the annular groove 41 when seen from the direction orthogonal to the direction of the axis L. The inclination angle θ2 formed by the tapered inner wall surface 41a and the tapered inner wall surface 41b that define the annular groove 41 is the angle corresponding to the inclination angle θ1 of the annular chamfered surface 13 to the annular outer peripheral surface 14 of the optical filter 2. With the rear abutment 22 formed, the annular groove 41 is closed. Specifically, in swaging processing, the rear end 18a of the annular plate 18 is bent until the tapered inner wall surface 41a comes in contact with the tapered inner wall surface 41b to form the rear abutment 22. Thus, the rear abutment 22 can be formed with weak force, and the rear abutment 22 can also be formed accurately. Hence, the optical filter 2 can be gripped securely by the front abutment 21 and the rear abutment 22.

As illustrated in FIG. 4B, an annular groove 42 according to a second modification is disposed on the outer peripheral surface of the annular plate 18. The annular groove 42 has a rectangular sectional shape, and is formed at a position overlapping the corner 15 when seen from the direction orthogonal to the direction of the axis L. Thus, the rear abutment 22 can be formed with weak force, and the rear abutment 22 can also be formed accurately. Hence, the optical filter 2 can be gripped securely by the front abutment 21 and the rear abutment 22. Note that the annular groove may be disposed on both the outer peripheral side and the inner peripheral side of the annular plate 18.

As illustrated in FIG. 4C, when the optical filter 2 does not include the annular chamfered surface 13, the annular groove 42 according to the second modification is disposed on the annular plate 18. The annular groove 42 is formed at a position where a corner 12a on the border between the annular outer peripheral surface 14 and the rear filter surface 12 is included in the annular groove 42 when seen from the direction orthogonal to the direction of the axis L. The rear end 18a of the annular plate 18 is bent along the rear filter surface 12 through swaging to form the rear abutment 22. Thus, the rear abutment 22 can be formed with weak force, and the rear abutment 22 can also be formed accurately. Hence, the optical filter 2 can be gripped securely by the front abutment 21 and the rear abutment 22.

### Second Embodiment

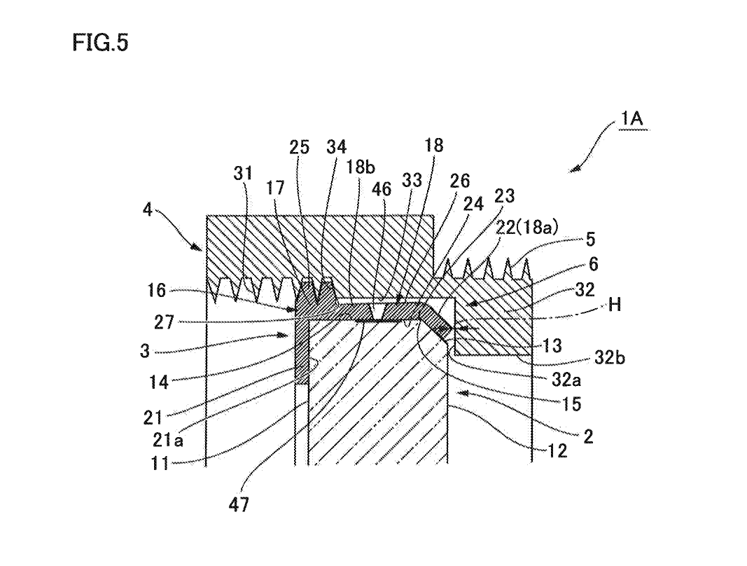

FIG. 5 is a diagram illustrating a camera filter unit according to a second embodiment. In a camera filter unit 1A according to the present embodiment, the filter holding ring 3 includes adhesive injection holes 46 in the annular plate 18. An adhesive 47 is interposed between the filter holding ring 3 and the optical filter 2. Note that the other components are the same as those of the camera filter unit 1 according to the first embodiment illustrated in FIG. 2, are denoted by the same reference numerals, and description thereof will be omitted.

As illustrated in FIG. 5, the adhesive injection holes 46 penetrate the cylinder 18b of the annular plate 18 in the direction orthogonal to the axis L. Three adhesive injection holes 46 are disposed at equal angular intervals in the circumferential direction of the cylinder 18b. Each of the adhesive injection holes 46 includes a tapered inner peripheral surface the inner diameter dimension of which decreases from the outer peripheral side toward the inner peripheral side. The adhesive 47 is injected into the inner peripheral side of the filter holding ring 3 through the adhesive injection holes 46. The adhesive 47 enters between the annular outer peripheral surface 14 of the optical filter 2 and the filter holding surface 24 of the filter holding ring 3.

In the present embodiment, the adhesive 47 interposed between the filter holding ring 3 and the optical filter 2 enables the optical filter 2 to be fixed to the filter holding ring 3 more securely. Additionally, the filter holding ring 3 includes the adhesive injection holes 46, and thus the adhesive 47 can be injected between the filter holding ring 3 and the optical filter 2 easily. Furthermore, the adhesive injection holes 46 are formed in the filter holding ring 3, and thus the adhesive injection holes 46 are hidden by the filter frame 4 so as not to be exposed outside when the filter holding ring 3 is screwed in and fixed to the filter frame 4. Consequently, no processing such as sealing of the adhesive injection holes 46 after injection of the adhesive 47 needs to be performed so as to maintain the appearance of the camera filter unit. Note that the number of the adhesive injection holes 46 may be one, or more than four adhesive injection holes 46 may be formed in the cylinder 18b.

In the present embodiment, the adhesive 47 fixes the optical filter 2 to the filter holding ring 3, and thus the optical filter 2 may be gripped by the front abutment 21 and the rear abutment 22 with weaker force than that in the case where the adhesive 47 is not used. Consequently, the rear abutment 22 can be formed with weak force.

### Third Embodiment

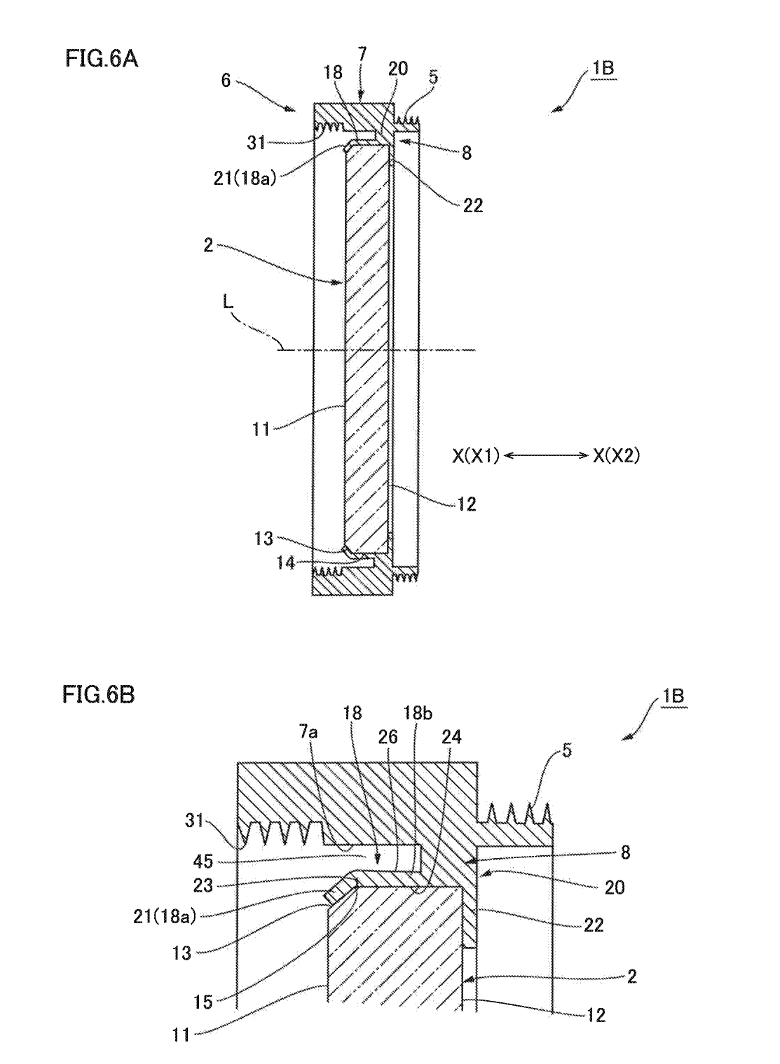

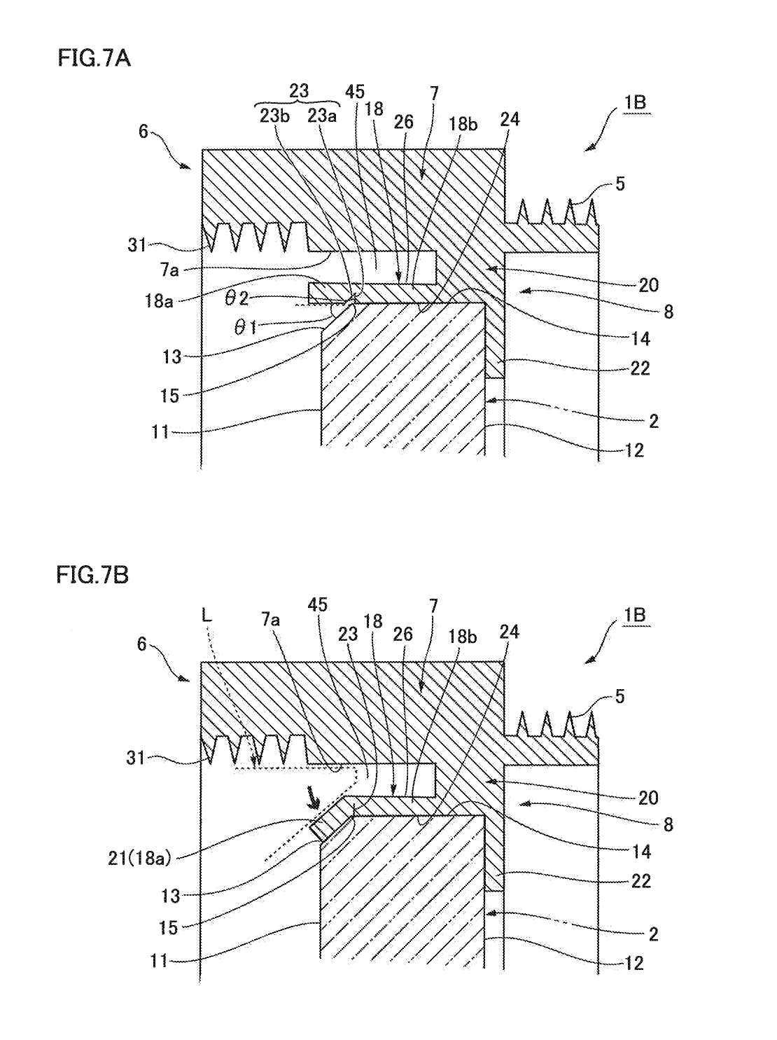

FIG. 6A is a longitudinal sectional view schematically illustrating a camera filter unit according to a third embodiment. FIG. 6B is a partially enlarged sectional view in which the vicinity of the outer peripheral edge of the optical filter 2 is enlarged. FIGS. 7A and 7B are diagrams for explaining a manufacturing method of the camera filter unit according to the third embodiment. In a camera filter unit 1B according to the present embodiment, the optical filter 2 includes the tapered annular chamfered surface 13 that is continuous to the outer peripheral edge of the front filter surface 11 and inclines to the outer peripheral side toward the rear X2. To the outer peripheral end edge of the annular chamfered surface 13, the annular outer peripheral surface 14 is continuous, extending to the rear X2. Between the annular chamfered surface 13 and the annular outer peripheral surface 14 is the corner 15. Note that the optical filter 2 includes no annular chamfered surface on the outer peripheral side of the rear filter surface 12. The camera filter unit 1B according to the present embodiment includes components corresponding to those of the camera filter unit 1 according to the first embodiment, and the same reference numerals are given to the corresponding components.

As illustrated in FIG. 6A, the camera filter unit 1B has the optical filter 2 and the camera filter frame 6 that holds the optical filter 2 coaxially. The optical filter 2 is disposed without being exposed from the front and rear ends of the camera filter frame 6. The camera filter frame 6 includes a frame body 7 and an annular filter holder 8 that is disposed on the inner peripheral side of the frame body 7.

The frame side external thread 5 is formed on the outer peripheral surface of the rear end of the filter body 7. The frame side external thread 5 is a mounting portion for mounting the camera filter unit 1B into a lens-barrel of an imaging lens or a camera. The frame side internal thread 31 is formed on the inner peripheral surface of the front end of the filter body 7. The frame side internal thread 31 is used as an attaching portion of a lens cap and a hood or a coupling portion for coupling other camera filter units. The filter holder 8 is disposed to the rear X2 of the frame side internal thread 31.

As illustrated in FIG. 6B, the filter holder 8 includes a coupling portion 20 the end of the outer peripheral side of which is continuous to the frame body 7, and the annular plate 18 that extends from the end of the inner peripheral side of the coupling portion 20 to the front X1. On the rear end edge of the coupling portion 20, the rear abutment (first abutment) 22 is formed. The rear abutment 22 is an annular protrusion protruding from the coupling portion 20 to the inner peripheral side. The rear abutment 22 abuts, from the rear X2, on the outer peripheral edge of the rear filter surface 12 of the optical filter 2 inserted into the inner peripheral side of the ring body 16 to prevent the optical filter 2 from moving to the rear X2.

A front end 18a of the annular plate 18 is the front abutment (second abutment) 21 that extends along the annular chamfered surface 13 of the optical filter 2. The front abutment 21 abuts, from the front X1, on the annular chamfered surface 13 of the optical filter 2 inserted into the inner peripheral side of the filter holder 8 to prevent the optical filter 2 from moving to the front X1. The front abutment 21 and the rear abutment 22 grip the optical filter 2 from both sides in the direction of the axis L.

The portion of the annular plate 18 toward the rear X2 from the front abutment 21 is the cylinder 18b. The annular inner peripheral surface of the cylinder 18b is seamlessly continuous to the annular inner peripheral surface of the coupling portion 20, and these annular inner peripheral surfaces constitute the filter holding surface 24 that holds the optical filter 2 from the outer peripheral side. The cylinder 18b also includes the ring side annular outer peripheral surface 26 that is smooth and has a constant diameter dimension. Between the ring side annular outer peripheral surface 26 and an inner peripheral surface 7a of the frame body 7, a clearance 45 is formed.

The annular plate 18 includes the annular groove 23 on its inner peripheral surface. The front abutment 21 is formed by bending the portion of the annular plate 18 in which the annular groove 23 is disposed, along the corner 15 toward the inner peripheral side. The annular groove 23 is closed with the front abutment 21 formed.

Manufacturing Method of Camera Filter Unit

As illustrated in FIG. 7A, to manufacture the camera filter unit 1B, the optical filter 2 is first fitted from the front X1 into the camera filter frame 6 without the front abutment 21 disposed. Swaging processing is then performed in which the front end 18a of the filter holder 8 (the front end 18a of the annular plate 18) is bent toward the inner peripheral side.

As illustrated in FIG. 7A, in the state before the front abutment 21 is provided, the front end 18a of the annular plate 18 extends parallel to the annular outer peripheral surface 14 of the optical filter 2 (parallel to the axis L). The annular groove 23, which is disposed on the inner peripheral surface of the annular plate 18, indicates a triangular sectional shape tapering toward the outer peripheral side when the filter holding ring 3 is cut by a plane including the axis L. The annular groove 23 is disposed in a portion located outside in the radial direction of the corner 15 on the border between the annular chamfered surface 13 and the annular outer peripheral surface 14 of the optical filter 2.

The annular groove 23 is defined by the annular inner wall surface 23a orthogonal to the axis L and the tapered inner wall surface 23b inclining from the end of the outer peripheral side of the annular inner wall surface 23a to the inner peripheral side toward the front X1. The height dimension of the annular inner wall surface 23a (the depth dimension of the annular groove 23) is one third of the thickness dimension of the annular plate 18. With the optical filter 2 abutting on the rear abutment 22, the annular inner wall surface 23a is located slightly closer to the rear X2 than the corner 15 of the optical filter 2 is. Thus, when seen from the direction orthogonal to the direction of the axis L, the annular groove 23 and the corner 15 overlap one another. The corner 15 is located closer to the end edge of the inner peripheral side of the annular inner wall surface 23a than the end edge of the inner peripheral side of the tapered inner wall surface 23b. Additionally, the inclination angle θ2 of the tapered inner wall surface 23b to the annular inner wall surface 23a is 45°, which corresponds to the inclination angle 81) (45° of the annular chamfered surface 13 to the annular outer peripheral surface 14 of the optical filter 2.

In the swaging processing, a swaging die L is inserted from the front X1 into the clearance 45 between the annular plate 18 and the frame body 7, and a force is applied to the front end 18a of the annular plate 18. As a result, the annular plate 18 starts being deformed from the portion where the annular groove 23 is formed.

Subsequently, the front end 18a of the annular plate 18 is bent to the inner peripheral side with the swaging die L until the annular groove 23 is closed. In this manner, the optical filter 2 is gripped from both sides in the direction of the axis L by the front abutment 21 and the rear abutment 22, thereby being fixed to the filter holding ring 3. This completes the camera filter unit 1.

The working effect similar to that of the first embodiment can be obtained also in the present embodiment. The annular grooves similar to those of the first and the second embodiments can be employed also in the present embodiment. Furthermore, as in the second embodiment, the annular plate 18 can include the adhesive injection holes 46, and the adhesive 47 can be interposed between the annular plate 18 and the optical filter 2 also in the present embodiment. In disposing the adhesive injection holes 46 in the annular plate 18, in order to inject the adhesive 47 between the annular plate 18 and the optical filter 2 through the adhesive injection holes 46, it is preferable to form a through hole in the frame body 7 at a position overlapping each of the adhesive injection hole 46 when seen from the radial direction and to allow a nozzle for injecting the adhesive 47 to be inserted into the adhesive injection hole 46 through the through hole.

### Modification of Third Embodiment

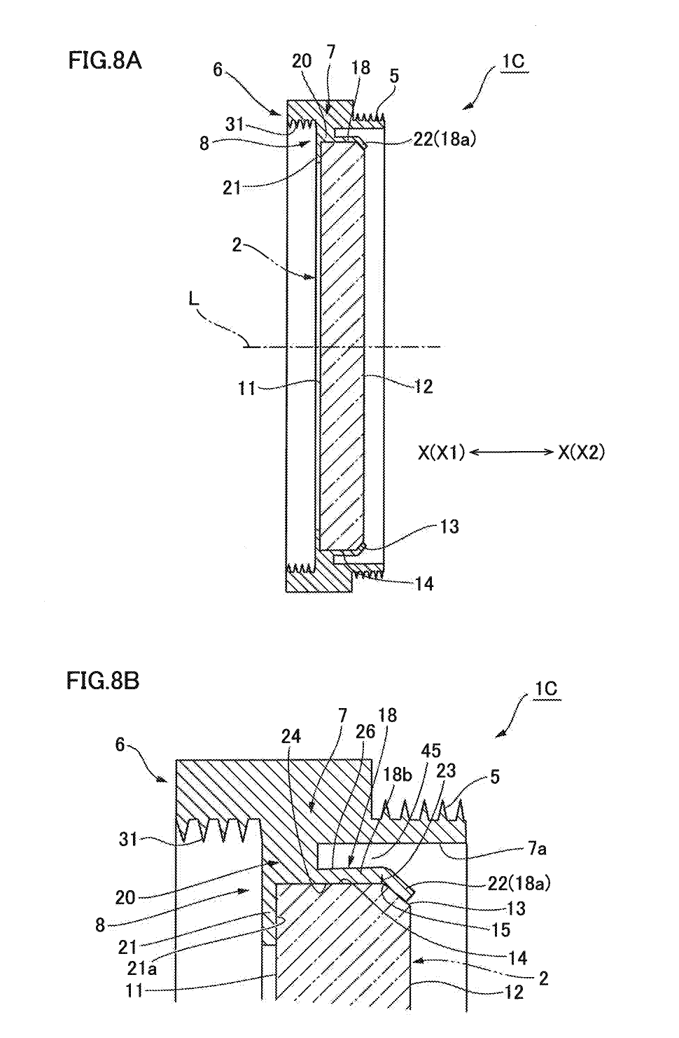

FIGS. 8A and 8B are diagrams illustrating a camera filter unit according to a modification of the third embodiment. Note that a camera filter unit 1C according to the present embodiment includes components corresponding to those of the camera filter unit 1B according to the second embodiment, and thus the same reference numerals are given to the corresponding components and description thereof will be omitted.

In a camera filter unit 1C according to the present embodiment, the optical filter 2 includes the tapered annular chamfered surface 13 that is continuous to the outer peripheral edge of the rear filter surface 12 and inclines to the outer peripheral side toward the front X1. To the outer peripheral end edge of the annular chamfered surface 13, the annular outer peripheral surface 14 is continuous, extending to the front X1. Between the annular chamfered surface 13 and the annular outer peripheral surface 14 is the corner 15. The optical filter 2 includes no annular chamfered surface on the outer peripheral side of the front filter surface 11.

In the camera filter unit 1C according to the present embodiment, the filter holder 8 includes the coupling portion 20 and the annular plate 18 in this order from the front X1 toward the rear X2. The annular plate 18 extends from the end of the inner peripheral side of the coupling portion 20 to the rear X2. On the front end edge of the coupling portion 20, an annular protrusion protruding to the inner peripheral side is formed, and the annular protrusion is the front abutment 21 that abuts on the optical filter 2 from the front X1. The rear end 18a of the annular plate 18 is the rear abutment 22 being bent toward the inner peripheral side through swaging. The rear abutment 22 abuts on the optical filter 2 from the rear X2 to prevent the optical filter 2 from moving to the rear X2.

To manufacture the camera filter unit 1C, the optical filter 2 is inserted from the rear X2 into the annular plate 18 in the state before the rear end 18a is bent toward the inner peripheral side. Thereafter, the rear end 18a of the annular plate 18 is bent toward the inner peripheral side through swaging. The annular groove 23 the sectional shape of which is a triangle is disposed on the inner peripheral surface of the annular plate 18 also in the present embodiment. The annular groove 23 is defined by the annular inner wall surface 23a orthogonal to the axis L and the tapered inner wall surface 23b inclining from the end edge of the outer peripheral side of the annular inner wall surface 23a to the inner peripheral side toward the rear X2, similarly to the annular groove 23 according to the first embodiment. When seen from the direction orthogonal to the direction of the axis L, the annular groove 23 and the corner 15 overlap one another.

Forming the annular groove 23 provides a thin portion in the annular plate 18, and thus the annular plate 18 is deformed from the portion where the annular groove 23 is formed by performing the swaging processing in which the rear end 18a of the annular plate 18 is bent toward the inner peripheral side also in the present embodiment. Thus, in the swaging processing, the rear abutment 22 can be formed with weak force, and the rear abutment 22 can also be formed accurately. Hence, the optical filter 2 can be gripped securely by the front abutment 21 and the rear abutment 22.

What is claimed is:

1. A camera filter frame comprising:
an annular plate into which an optical filter is inserted on an inner peripheral side; and
a first abutment and a second abutment that grip the optical filter by abutting on the optical filter from one side and the other side in an axial direction, the second abutment being formed by causing an end on the other side of the annular plate in the axial direction to be bent toward the inner peripheral side, wherein
the annular plate includes an annular groove on at least one of an outer peripheral surface and an inner peripheral surface, and
the second abutment is formed by bending a portion of the annular plate in which the annular groove is formed toward the inner peripheral side.

2. The camera filter frame according to claim 1, wherein
the second abutment abuts on a tapered chamfered surface disposed between a filter surface and an annular outer peripheral surface of the optical filter, and
the annular groove is disposed at a position overlapping a corner between the annular outer peripheral surface and the chamfered surface when the optical filter abutting on the first abutment in a state before the annular plate is bent is seen from a direction orthogonal to the axial direction.

3. The camera filter frame according to claim 2, wherein
the annular groove is disposed on the inner peripheral surface, and
the annular groove has a triangular sectional shape tapering toward an outer peripheral side in the state before the annular plate is bent.

4. The camera filter frame according to claim 3, wherein the annular groove includes an annular inner wall surface that is flat and extends orthogonally to the axial direction and a tapered inner wall surface that inclines from an end of the outer peripheral side of the annular inner wall surface to the inner peripheral side toward the other side in the axial direction.

5. The camera filter frame according to claim 4, wherein
the annular groove is closed with the second abutment formed.

6. The camera filter frame according to claim 1, wherein the annular plate includes, on one side of the annular groove in the axial direction, an adhesive injection hole that penetrates in a direction intersecting the axial direction.

7. The camera filter frame according to claim 1, further comprising:
a filter holding ring that includes the annular plate, the first abutment, and the second abutment; and
a filter frame that holds the filter holding ring on the inner peripheral side, wherein
the filter frame includes a stopper that is abuttable on the second abutment when the second abutment comes apart from the optical filter.

8. A camera filter unit comprising:
the camera filter frame according to claim 1; and
an optical filter held by the camera filter frame.
